(19) United States
(12) Patent Application Publication
(10) Pub. No.: US 2012/0300478 A1
(43) Pub. Date: Nov. 29, 2012

(54) 10 foot multi directon splitter light

(75) Inventor: Jacob Foss, Poulsbo, WA (US)

(73) Assignee: Jacob Jon Foss, Poulsbo, WA (US)

(21) Appl. No.: 13/464,883

(22) Filed: May 4, 2012

Related U.S. Application Data
(60) Provisional application No. 61/482,778, filed on May 5, 2011.

(51) Int. Cl. F21V 21/00

(52) U.S. Cl. 362/382

(57) ABSTRACT

On one end is a 120 volt male cord end, on either side of the male cord end is a rubber loop. The middle is made up of 10 foot rubber coated 12 gage wires like an extension cord type. In the center of the 10 foot section is a plastic molded medium base light bulb socket. Over the part of the socket that holds the light bulb, there is a plastic protective cage for the light bulb. On the final end of the product there is a 3 way 3 directional female splitter, there is reversed hooks on either side of each female socket to except the rubber loops that are on the male end of the next like product to extend the entire product.

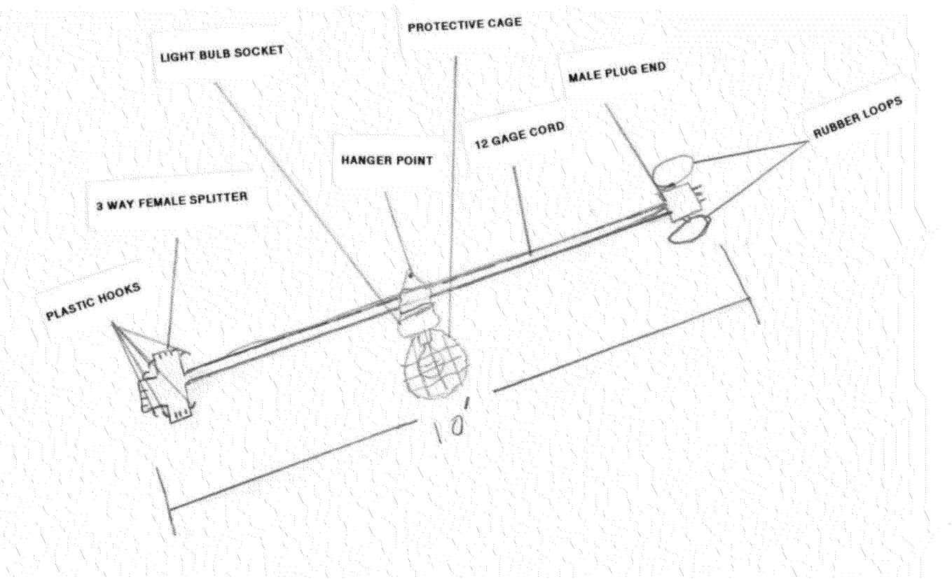

### CROSS REFERENCE

This is a utility patent to a provisional patent No. 61/482,778

### BACKGROUND

This product is easier to run in multiple directions because it is 10 ft lengths and has a 3 way splitter at the female end. the other 150 foot common string lights have to overlap to run in different directions, this product in 10 foot pieces, each 10 foot has its own light socket, so if a light socket goes bad you can replace that one 10 foot piece. The other products you cannot replace sockets or the section of the cord that goes bad. Also, the invention being in 10 foot lengths is easier to assemble and disassemble in hard to get to places.

### SUMMARY

This is a 10 foot 12 gage wire extension cord type cord with a molded light socket and plastic bulb cage in the center. At the female power end is a 3 directional splitter, on either side of the splitter sockets are reversed hooks to hold the rubber rings that are on the male end so the next 10 foot piece that is added doesn't pull apart.

Parts: 120 volt male plug, 10 feet of 12 gage extension type cord, 1 plastic molded medium base light bulb socket, plastic light bulb protective cage, 3 way 3 directional female splitter, reversed hooks on the female splitter, rubber loops attached to the male cord end,

### DETAILED DESCRIPTION

120 volt 20 amp male plug with rubber rings on either side 10 foot 12 gage extension cord type cord with a molded plastic medium base light bulb socket that has a plastic light bulb protective cage and a 3 way 3 directional female splitter and on either side of each female socket are reversed hooks.

Operation: the male end is plugged into a 120 volt receptacle which in turn energizes the 10 foot extension cord type cord, illuminating the light in the socket in the center of the 10 foot cord energizing the 3 directional female splitter at the other end allowing another 10 foot cord being plugged in going in any one of the 3 directions and so on and so forth being held together by the reversed hooks and rubber loops

1. The male cord end is plugged into 120 volt outlet energizing the cord in turn energizing the light socket in the middle of the 10 foot 12 gage extension cord type cord and also energizing the 3 way female splitter at the end of the cord. If another 10 foot piece is added, when the male cord end is plugged into the female splitter, the rubber loops attached to the male cord end will be secured to the hooks on the female splitter for the purpose for holding the female and male together.

2. On one end is a male cord end with rubber loops on either side, the cord end is wired to a 10 foot 12 gage extension cord type cord. In the center of the cord is a medium base light bulb socket with a protective light bulb cage, on the top of the socket, is a hanger point to secure the cord in place while in use. On the opposite end of the cord, is a 3 directional 3 way splitter with hooks on either side of the female plug to accept the rubber loops that are on the male plug of the next 10 foot piece to be added.
